(19) United States
(12) Patent Application Publication
(10) Pub. No.: US 2026/0231967 A1
(43) Pub. Date: Aug. 13, 2026

(54) METHOD FOR THE RAPID OSMOTIC DRYING OF FOOD

(71) Applicant: Texas Tech University System, Lubbock, TX (US)

(72) Inventor: Richard Schlomer Meyer, Harrison, ID (US)

(21) Appl. No.: 19/244,332

(22) Filed: Jun. 20, 2025

Related U.S. Application Data
(63) Continuation-in-part of application No. 17/251,878, filed on Jun. 13, 2019, now Pat. No. 12,357,000.
(60) Provisional application No. 62/685,657, filed on Jun. 15, 2018.

(51) Int. Cl. A23B 2/40; A23B 2/30; A23B 2/754; A23B 2/90

(52) U.S. Cl. CPC A23B 2/405; A23B 2/30; A23B 2/754; A23B 2/90

(57) ABSTRACT

A method for preparing a shelf-stable, high-moisture food product comprising: a first pasteurizing step of a food item to kill microbes except spores comprising heating the pasteurized food item to a water activity between 0.88 and 0.92, wherein the food product is at least one of: heated to a final internal temperature of 160° F. for one minute; heated to a final internal temperature of 165° F. for one second; or heated to a final internal temperature of 165° F.; vacuum-packing the heated food product in an oxygen impermeable and water-impermeable membrane, wherein no preservatives are added, no gas flushing is performed, and no oxygen absorber is added and having a water activity between 0.88 and 0.92; and a second pasteurizing step of the food item in the package, wherein the food item in the package is shelf-stable and has a water activity of 0.88 and 0.92.

### CROSS-REFERENCE TO RELATED APPLICATIONS

This application claims priority to U.S. patent application Ser. No. 18/250,004, filed Dec. 21, 2023, which claims priority to under 35 U.S.C. 371 of PCT/US2021/056742, filed Oct. 27, 2021, and to U.S. Provisional Application Ser. No. 63/107,037, filed Oct. 29, 2020, and to U.S. patent application Ser. No. 17/251,878, filed Dec. 14, 2020, which claims priority to under 35 U.S.C. 371 of PCT/US2019/036956, filed Jun. 13, 2019, and to U.S. Provisional Application Ser. No. 62/685,657, filed Jun. 15, 2018, the entire contents of which are incorporated herein by reference.

### STATEMENT OF FEDERALLY FUNDED RESEARCH

None.

### TECHNICAL FIELD OF THE INVENTION

The present invention relates in general to the field of food preparation and preservation. In particular, the present invention relates to preparation and preservation of shelf-stable, high-moisture, all-natural food products.

### BACKGROUND OF THE INVENTION

Without limiting the scope of the invention, its background is described in connection with the preparation and preservation of snack foods.

Current dried foods such as dried fruit and jerky are tough and hard to chew and generally have preservatives such as nitrites, sulfites, sodium benzoate, calcium propionate, nitrogen flush or carbon dioxide flush with an oxygen absorber, etc., added to make them shelf-stable. The high moisture foods (0.89 water activity), such as steak strips or meat strips, are loaded with unnatural preservatives to prevent bacterial, mold and yeast growth plus they are packed with a nitrogen flush or carbon dioxide flush with an oxygen absorber.

Natural preservatives such as cultured sugar contains propionic acid, but it has been found to have terrible flavor and tends to toughen the meat. When these natural preservatives were used on steak strips (plus potassium sorbate on the surface to prevent mold growth), in amounts effective to eliminate bacterial growth, it had a detectable cardboard-like off-flavor. Further, as a product ages with these so-called natural preservatives (whether with propionic acid or sodium propionate), these cause the meat to become dryer, tougher, and crumbly. Meat products become dryer, tougher, and crumbly with age, and this happens in all jerky products when an acidulant is used (e.g., BBQ flavor with an acid tanginess). Thus, there is a need to overcome these problems with the use of natural preservatives.

One such invention is taught in U.S. Pat. No. 6,099,881, issued to Hansen, which is said to teach a method of curing meat, or other food products, using nitrogen dioxide gas. Hansen teaches that the food product is exposed to nitrogen dioxide gas at a concentration in excess of 0.4 ppm, and the nitrogen dioxide gas reacts with moisture in the food product to produce nitrous acid that diffuses throughout the product to cure the product and produce the pink “cured” color pigment. Alternatively, the nitrogen dioxide gas is dissolved in water to produce a solution containing nitrous acid, and the solution is injected into the food product to produce the cured color pigment. Thus, the nitrous acid is a preservative added to the meat product.

Another such invention is taught in U.S. Pat. No. 6,319,527, issued to Purser, which is said to teach a method of preparing a uniformly tender meat product having an extended shelf life by: selecting one or more meat ingredients wherein the muscle weight is comprised of whole protein tissue fibers, such as beef or pork, and mixing an acidulent with the meat to form a pretenderized meat product, thus acid cooking the meat. Subsequently, the pre-tenderized meat product is mixed with an enzymatic tenderizer and cooked. The finished product is typically packaged in an oxygen-impermeable film, which also contains a microbe-inhibiting atmosphere and an oxygen-moisture scavenging agent.

A need exists for a food product that has no preservatives, high moisture content so that it is soft and easy to chew, and that requires no gas flushing and no oxygen absorber.

### SUMMARY OF THE INVENTION

As embodied and broadly described herein, an aspect of the present disclosure relates to a method for preparing a shelf-stable, high-moisture food product, comprising: a first pasteurizing step of a food item to kill microbes except spores comprising heating the pasteurized food item to a water activity between 0.88 and 0.92, wherein the food product is at least one of: heated to a final internal temperature of 160° F. for one minute; heated to a final internal temperature of 165° F. for one second; or heated to a final internal temperature of 165° F.; vacuum-packing the heated food product in an oxygen impermeable and water-impermeable membrane, wherein no preservatives are added, no gas flushing is performed, and no oxygen absorber is added and having a water activity between 0.88 and 0.92; and a second pasteurizing step of the food item in the package, wherein the food item in the package is shelf-stable and has a water activity of 0.88 and 0.92. In one aspect, the food product comprises beef, chicken, fish, fruit, vegetable, nuts, seeds, or a blend thereof. In another aspect, the method steps are performed in a continuous production line. In another aspect, the food item is dried to a water activity between 0.88 and 0.92. In another aspect, the food item is dried to a water activity of about 0.90. In another aspect, the food item is dried to a water activity of 0.88, 0.90. 0.91, 0.92, or 0.93. In another aspect, no preservatives are added. In another aspect, no gas flushing is performed. In another aspect, no oxygen absorber is added. In another aspect, the method further comprises treating the food product with one or more natural enzyme inhibitors. In another aspect, the heating is dry or humid. In another aspect, the method further comprises heating the food product to at least 77° C. for a time sufficient to kill Salmonella and Listeria with at least a 5.0 log kill. In another aspect, the first, the second, or both the first and second pasteurizing steps are a two-step process: (1) drying or heating the food product to a water activity to the food product to 0.90-0.92 in a water permeable membrane in a water bath, and (2) drying or heating the food product in a second membrane that is water/O₂ impermeable in the water bath.

As embodied and broadly described herein, an aspect of the present disclosure relates to a method of preparing a shelf-stable, high-moisture food product, comprising: a first pasteurizing step of a raw food item to kill microbes except spores by heating the pasteurized food item to a water activity 0.88 to 0.92, wherein the food product is at least one of: heated to a final internal temperature of 160° F. for one minute; heated to a final internal temperature of 165° F. for one second; or heated to a final internal temperature of 165° F.; and vacuum-packing the dried food item in an oxygen impermeable and water-impermeable membrane, wherein no preservatives are added, no gas flushing is performed, and no oxygen absorber is added, and having a water activity between 0.88 and 0.92; and after drying the product, then a second pasteurizing step of the food item in the package, wherein the food item in the package is shelf-stable and a water activity of 0.88 and 0.92. In one aspect, the food item comprises beef, chicken, fish, fruit, vegetable, nuts, seeds, or a blended food. In another aspect, the method steps are performed in a continuous production line. In another aspect, the food product is dried to a water activity between 0.88 and 0.92. In another aspect, the food product is dried to a water activity of about 0.90. In another aspect, the food product is dried to a water activity of 0.88, 0.87, 0.88, 0.90. 0.91, 0.92, or 0.93. In another aspect, no preservatives are added. In another aspect, no gas flushing is performed. In another aspect, no oxygen absorber is added. In another aspect, the food product is treated with one or more natural enzyme inhibitors. In another aspect, the product is heated to at least 77° C. for a time sufficient to kill Salmonella and Listeria with at least a 5.0 log kill. In another aspect, the first, the second, or both the first and second pasteurizing steps are a two-step process: (1) drying or heating the food product to a water activity to the food product to 0.90-0.92 in a water permeable membrane in a water bath, and (2) drying or heating the food product in a second membrane that is water/O₂ impermeable in the water bath.

As embodied and broadly described herein, an aspect of the present disclosure relates to a method for preparing a shelf-stable, high-moisture food item, comprising: providing a raw food item in a raw state; preparing a brine; blending or injecting the food item and the brine; letting the food item set in the brine; removing the food item from the brine; placing the food item in an oven or smokehouse (e.g., a combi oven, a steam tunnel or a microwave heater/tunnel; removing the food item from the smokehouse or oven when a water activity of the food item is between 0.88 and 0.93; letting the food item cool; vacuum-packing the food item in an oxygen-impermeable and moisture-impermeable film; and a pasteurizing step of the food item by placing the food item, now vacuum-packed, wherein the food item is at least one of: dried or heated with a final internal temperature of 160° F. for one minute; dried or heated with a final internal temperature of 165° F. for one second; or dried or heated with a final internal temperature of 165° F., wherein no preservatives are added, no gas flushing is performed, and no oxygen absorber is added, wherein the food item in the package is shelf-stable and a water activity of 0.88 and 0.93. In one aspect, the food item comprises beef, chicken, fish, fruit, vegetable, nuts, seeds, or a blended food. In another aspect, the method steps are performed in a continuous production line. In another aspect, the food product is dried to a water activity between 0.88 and 0.92. In another aspect, the food product is dried to a water activity of about 0.90. In another aspect, the food product is dried to a water activity of 0.88, 0.87, 0.88, 0.90. 0.91, 0.92, or 0.93. In another aspect, no preservatives are added. In another aspect, no gas flushing is performed. In another aspect, no oxygen absorber is added. In another aspect, the food product is treated with one or more natural enzyme inhibitors. In another aspect, the product is heated to at least 77° C. for a time sufficient to kill Salmonella and Listeria with at least a 5.0 log kill. In another aspect, the first, the second, or both the first and second pasteurizing steps are a two-step process: (1) drying or heating the food product to a water activity to the food product to 0.90-0.92 in a water permeable membrane in a water bath, and (2) drying or heating the food product in a second membrane that is water/O₂ impermeable in the water bath.

As embodied and broadly described herein, an aspect of the present disclosure relates to a shelf-stable, high-moisture food product made by the method comprising: a first pasteurizing step of the food product to kill microbes except spores comprising heating the pasteurized food item to a water activity between 0.88 and 0.93, wherein the food product is at least one of: heated to a final internal temperature of 160° F. for one minute; heated to a final internal temperature of 165° F. for one second; or heated to a final internal temperature of 165° F.; vacuum-packing the heated food product in an oxygen impermeable and water-impermeable membrane, wherein no preservatives are added, no gas flushing is performed, and no oxygen absorber is added and having a water activity between 0.88 and 0.93; and a second pasteurizing step of the food item in the package, wherein the food item in the package is shelf-stable and has a water activity of 0.88 and 0.93. In one aspect, the food item comprises beef, chicken, fish, fruit, vegetable, nuts, seeds, or a blended food. In another aspect, the method steps are performed in a continuous production line. In another aspect, the food product is dried to a water activity between 0.88 and 0.92. In another aspect, the food product is dried to a water activity of about 0.90. In another aspect, the food product is dried to a water activity of 0.88, 0.87, 0.88, 0.90. 0.91, 0.92, or 0.93. In another aspect, no preservatives are added. In another aspect, no gas flushing is performed. In another aspect, no oxygen absorber is added. In another aspect, the food product is treated with one or more natural enzyme inhibitors. In another aspect, the product is heated to at least 77° C. for a time sufficient to kill Salmonella and Listeria with at least a 5.0 log kill. In another aspect, the first, the second, or both the first and second pasteurizing steps are a two-step process: (1) drying or heating the food product to a water activity to the food product to 0.90-0.92 in a water permeable membrane in a water bath, and (2) drying or heating the food product in a second membrane that is water/02 impermeable in the water bath.

As embodied and broadly described herein, an aspect of the present disclosure relates to a shelf-stable, high-moisture food product is disclosed as including drying or heating a pre-pasteurized food item to a water activity between 0.88 and 0.93; and vacuum-packing the dried food item in an oxygen impermeable and water-impermeable membrane. In one aspect, the food item comprises beef, chicken, fish, fruit, vegetable, nuts, seeds, or a blended food. In another aspect, the method further includes pasteurizing the vacuum-packed food item. In another aspect, the method further includes pre-pasteurizing the raw food item prior to the drying or heating step. In another aspect, the method steps are performed in a continuous production line. In another aspect, the food item is dried to a water activity between 0.88 and 0.92. In another aspect, the food item is dried to a water activity of about 0.90. In another aspect, the food item is dried or heated with an internal temperature for a sufficient time to pasteurize the food item. In another aspect, the food item is dried or heated with a final internal temperature of 160° F. for one minute. In another aspect, the food item is dried or heated with a final internal temperature of 165° F. for one second. In another aspect, the food item is dried or heated with a final internal temperature of 165° F. In another aspect, the food item is pasteurized in a water bath and achieves a final temperature of at least 160° F. for one minute. In another aspect, the food item is pasteurized in a water bath and achieves a final temperature of at least 165° F. for one second. In another aspect, no preservatives are used. In another aspect, no gas flushing is performed. In another aspect, no oxygen absorber is added. In another aspect, the method further includes treating the food item with one or more natural enzyme inhibitors. In another aspect, the method further comprises heating the product to at least 77° C. for a time sufficient to kill Salmonella and Listeria with at least a 5.0 log kill.

As embodied and broadly described herein, an aspect of the present disclosure relates to a shelf-stable, high-moisture food product using a continuous production line is disclosed as including optionally pre-pasteurizing a raw food item; drying or heating the pre-pasteurized food item to a water activity between 0.88 and 0.93; and vacuum-packing the dried food item in an oxygen impermeable and water-impermeable membrane.

As embodied and broadly described herein, an aspect of the present disclosure relates to a shelf-stable, high-moisture food product is disclosed, including providing a raw food item in a raw state; optionally pre-pasteurizing the raw food item; preparing a brine; blending or injecting the food item and the brine; letting the food item set in the brine; removing the food item from the brine; placing the food item in a smokehouse or oven (e.g., a combi oven, a steam tunnel or a microwave heater/tunnel); removing the food item from the smokehouse or oven when a water activity of the food item is 0.90 or greater; letting the food item cool; vacuum-packing the food item in an oxygen-impermeable and moisture-impermeable film; and pasteurizing the food item by placing the food item, now vacuum-packed, in a hot water bath. In another aspect, the method further comprises heating the product to at least 77° C. for a time sufficient to kill Salmonella and Listeria with at least a 5.0 log kill.

As embodied and broadly described herein, an aspect of the present disclosure relates to a shelf-stable, high-moisture food product is disclosed as including an item of beef, chicken, fish, fruit, vegetable, or a blended item that has been optionally pre-pasteurized in a raw state, dried to a water activity between 0.88 and 0.93, vacuum-packed in an oxygen impermeable and water-impermeable membrane. In one example, drying or heating can also be done by simple air-drying or Enwave's microwave vacuum drying—especially for fruits and vegetables. Heating can be in an oven at atmospheric humidity, a dry oven, or a moist or humidified oven in which moisture is injected into the oven (e.g., a combi, a steam tunnel or a microwave heater/tunnel). A post-process pasteurization takes care of any contamination from these air-drying or air-heating alternatives. In one aspect, the food item comprises beef, chicken, fish, fruit, vegetable, nuts, seeds, or a blended food. In another aspect, the item is pasteurized after vacuum-packing. In another aspect, the method steps are performed in a continuous production line. In another aspect, the food item is dried to a water activity between 0.88 and 0.92. In another aspect, the food item is dried to a water activity of about 0.90. In another aspect, the food item is dried or heated with an internal temperature for a sufficient time to pasteurize the food item. In another aspect, the food item is dried or heated with a final internal temperature of 160° F. for one minute. In another aspect, the food item is dried or heated with a final internal temperature of 165° F. for one second. In another aspect, the food item is dried or heated with a final internal temperature of 165° F. In another aspect, the food item is pasteurized in a water bath and achieves a final temperature of at least 160° F. for one minute. In another aspect, the food item is pasteurized in a water bath and achieves a final temperature of at least 165° F. for one second. For example, a post-process pasteurization in the package can also accomplished in a heated, continuous tunnel (or steam tunnel), or an air impingement oven (continuous flow of hot air). What is important is to heat the product in the package at a set temperature and holding for a time sufficient to achieve pasteurization. For example, a hot water bath provides energy efficiency and complete, uniform heat transfer (no cold spots). In another aspect, no preservatives are used. In another aspect, no gas flushing is performed. In another aspect, no oxygen absorber is added. In another aspect, the food item has been treated with one or more natural enzyme inhibitors. In another aspect, the method further comprises heating the product to at least 77° C. for a time sufficient to kill Salmonella and Listeria with at least a 5.0 log kill.

In addition to the foregoing, various other method, system, and apparatus aspects are set forth in the teachings of the present disclosure, such as the claims, text, and drawings forming a part of the present disclosure.

The foregoing is a summary and thus contains, by necessity, simplifications, generalizations, and omissions of detail. Consequently, those skilled in the art will appreciate that this summary is illustrative only and is not intended to be in any way limiting. There aspects, features, and advantages of the devices, processes, and other subject matter described herein will be become apparent in the teachings set forth herein.

### BRIEF DESCRIPTION OF THE DRAWINGS

For a more complete understanding of the features and advantages of the present invention, reference is now made to the detailed description of the invention along with the accompanying figures, in which:

FIG. 1 shows a flowchart of a method embodiment of the present invention.

FIG. 2 shows a flowchart of another method embodiment of the present invention.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The present invention is and produces an all-natural food that has no preservatives, that has a texture that is soft and easy to chew, and that requires no gas flushing and an oxygen absorber. This process also allows the moisture to go higher (0.88, 0.87, 0.88, 0.90. 0.91, 0.92, or 0.93) to enhance the moistness and to generate a softer, more pleasant texture that is easier to chew.

As used herein, the term “water activity” or “a_{w}” refers to a partial vapor pressure of water in a substance divided by the standard state partial vapor pressure of water. In the field of food science, the standard state is most often defined as the partial vapor pressure of pure water at the same temperature. As such, pure distilled water has a water activity of exactly one. As temperature increases, a_{w} typically increases, except in some products with crystalline salt or sugar. Substances with a higher a_{w} tend to support more microorganisms, for example, bacteria usually require at least 0.91, and fungi at least 0.7. Water activity can be understood as the amount of water available for hydration of materials (water activity=water availability). As such, when the water is all available, a_{w}=1, and when none is available, a_{w}=0. See also, www.fda.gov/inspections-compliance-enforcement-and-criminal-investigations/inspection-technical-guides/water-activity-aw-foods, relevant portions incorporated herein by reference.

The food product of the present invention can include meat, seafood, fruit, vegetable, nuts, seeds, or a blended food product.

The present invention encompasses a number of processes for producing a shelf-stable, high-moisture food snack. These processes include but are not limited to the following:

(1) A food is pre-pasteurized, an initial pasteurization in which all microbes except spores are killed, and dried or heated to a water activity between 0.88 and 0.93, e.g., 0.88, 0.90. 0.91, 0.92, or 0.93, vacuum packed in a water and oxygen impermeable membrane, then subjected to a pasteurization process in the package.

(2) The food product is dried in a smokehouse or oven with an internal temperature and time sufficient to pasteurize the product and dried or heated to a water activity between 0.88 and 0.93, e.g., 0.88, 0.90. 0.91, 0.92, or 0.93, vacuum packed in a water and oxygen impermeable membrane, then subjected to a pasteurization process.

(3) The food product is dried in a smokehouse or oven with a final internal temperature achieving at least 160° F. for one minute and dried or heated to a water activity between 0.88 and 0.93, e.g., 0.88, 0.90. 0.91, 0.92, or 0.93, vacuum packed in a water and oxygen impermeable membrane, then subjected to a pasteurization process.

(4) The food product is dried or heated in a smokehouse or oven with a final internal temperature, e.g., achieving 165° F. for one second and dried to a water activity between 0.88 and 0.93, e.g., 0.88, 0.87, 0.88, 0.90. 0.91, 0.92, or 0.93, vacuum packed in a water and oxygen impermeable membrane, then subjected to a pasteurization process.

(5) The food product is dried or heated in a smokehouse or oven with a final internal temperature, e.g., achieving 165° F., and dried or heated to a water activity, more preferably, between 0.88 and 0.93, e.g., 0.88, 0.90. 0.91, 0.92, or 0.93, vacuum packed in a water and oxygen impermeable membrane, then subjected to a pasteurization process.

(6) The food product is dried or heated in a smokehouse or oven with a final internal temperature, e.g., achieving 165° F. and dried to a water activity, more preferably, between 0.88 and 0.93, e.g., 0.88, 0.90. 0.91, 0.92, or 0.93, vacuum packed in a water and oxygen impermeable membrane then subject to a pasteurization process where the pasteurization process is a commercial heating process such as a water bath, with the product achieving an internal temperature of at least 160° F. for one minute or 165° F. for one second.

In processing the food snack in accordance with the present invention, either a pre-pasteurization or a pasteurization after vacuum-packing is required, but if the product is pasteurized after vacuum-packing, the pre-pasteurization is optional. One skilled in the art of food processing will recognize that this may be the case in scenarios described herein in which both pre-pasteurization and pasteurization after vacuum-packing is discussed.

As used throughout the specification non-limiting examples of ovens include: regular ovens, a combination oven, a steam tunnel, and/or a microwave heater/tunnel. A combination (or combi oven) oven is a three-in-one oven that allows cooking with steam, hot air (convection), or a combination of both. Separate steamer, convection, steam tunnel, and/or microwave heater/tunnel ovens can also be used.

In one non-limiting exemplary process, beef is prepared according to an embodiment of the present invention as described in Table 1.

| | Surface tumble on brine | | Inject brine |
|---|---|---|---|
| 1A | Slice top round at 2.5 cm (1 inch) | 1B | Use whole top rounds and don't slice |
| | across the grain and 12 mm (½ inch) | | until after pumped. |
| | thick and natural length | | |
| 2A | Blend brine formula and place strips | 2B | Blend brine formula and inject at |
| | into the brine. | | a 33% pump |
| 3A | Blend together with a slow tumble | 3B | Vacuum (10″) tumble pumped top rounds |
| | for 5 minutes. | | (4) at the rate of 5 RPM's for 1 hour. |
| 4A | Let set over night in the brine. | 4B | Let set over night in the brine at 40° F.; |
| | | | no retumble was needed; no free brine. |
| | | | Slice top round at 2.5 cm (1 inch) across |
| | | | the grain and 12 mm (½ inch) thick and |
| | | | natural length. |
| 5A | Place strips on plastic grid on a flat | 5B | Place strips on plastic grid on a flat tray |
| | tray with strips not touching. | | with strips not touching. |
| 6A | Place on a trays on a rack and move | 6B | Place on a trays on a rack and move into |
| | into the smokehouse. | | the smokehouse. |
| 7A | Start smokehouse process according | 7B | Start smokehouse process according to |
| | to schedule. | | schedule. |
| 8A | Pull strips near the end of the | 8B | Pull strips near the end of the |
| | smokehouse schedule to see how | | smokehouse schedule to see how close to |
| | close to 0.90 water activity. | | 0.90 water activity. |
| 9A | When 0.90 water activity achieved, let | 9B | When 0.90 water activity achieved, let |
| | cool then individually vacuum pack | | cool then individually vacuum pack each |
| | each strip in an oxygen & moisture | | strip in an oxygen & moisture barrier film. |
| | barrier film. | | |
| 10A | Place the vacuum packed strips into a | 10B | Place the vacuum packed strips into a hot |
| | hot water bath (180° F.) for a period | | water bath (180° F.) for a period |
| | sufficient to fully pasteurize the strip. | | sufficient to fully pasteurize the strip. |
| 11A | Pull samples after 10 minutes and 20 | 11B | Pull samples after 10 minutes and 20 |
| | minutes. | | minutes. |
| 12A | Conduct micro testing on samples | 12B | Conduct micro testing on samples pulled |
| | pulled at various times to confirm that | | at various times to confirm that full |
| | full pasteurization has been achieved. | | pasteurization has been achieved. |

In a non-limiting exemplary process embodiment, two preparations are made as described in this Table 2.

| Ingredient | % | A | | B | |
|---|---|---|---|---|---|
| Beef, Top Round | 75.00% | 10.27 | lbs. | 33% | |
| | | | | pump into | |
| | | | | top rounds | |
| Brine: | 3.423 lbs. | | | 50 | pounds |
| Nitrite cure: | | 8.94 | grams | 130.64 | grams |
| nitrites or celery | | | | | |
| powder (also called | | | | | |
| fermented celery | | | | | |
| juice or swiss | | | | | |
| chard powder), | | | | | |
| (120 ppm nitrite) | | | | | |
| Brown sugar | 10.00% | 621.11 | grams | 15 | lbs. |

| sea salt # 57 | 1.40% | 78.02 | real salt | |
|---|---|---|---|---|
| | | | 2.512 | lbs. |
| black pepper, | 0.12% | 7.453 | 0 | |
| fine, 60 mesh | | | | |
| Garlic powder | 0.30% | 18.633 | 272.16 | grams |
| onion powder | 0.20% | 12.422 | 181.44 | grams |
| Bay leaf, ground | 0.10% | 6.211 | 90.816 | grams |
| Maxarome | 0.10% | 6.211 | 90.816 | grams |
| yeast extract | | | | |
| Clear valley | 0.40% | 24.8445 | 0.8 | lbs. |
| sunflower oil | | | | |
| smoke (0.3%) | | burn chips; | burn chips; | |
| | | 1 hour burn | 1 hour burn | |
| | | hickory | hickory | |
| peach flavor 582483 | 0.0010% | 0.062 | 0.907 | grams |
| mango flavor 522473 | | 0 | 0 | |
| water | 12.00% | 745.337 | 24 | lbs. |
| Natural Umami flavor | 0.30% | 18.633 | 272.16 | grams |
| | 99.9210% | | | |

The following table shows a non-limiting exemplary smokehouse or oven schedule for testing of a process embodiment of the present invention in Table 3.

TABLE 3
Smokehouse or oven schedule.

| | Cook Time | Dry | Wet | | | | Special Notes |
|---|---|---|---|---|---|---|---|
| Stage | (minutes) | Bulb | Bulb | RH | Exhaust | Steam | on Process |
| 1 | 10 | 160 | 104 | 25% | on | off | |
| 2 | 10 | 170 | 121 | 25% | on | on | |
| 3 | 10 | 180 | 128 | 25% | on | on | |
| 4 | 10 | 195 | 140 | 25% | on | on | |
| 5 | 30 | 205 | 165 | 40% | on | on | stop when |
| | | | | | | | meat internal |
| | | | | | | | temperature |
| | | | | | | | hits 160° F. |
| 6 | 10 | 180 | 134 | 30% | on | on | |
| 7 | 40 | 180 | 134 | 30% | on | on | |
| 8 | 10 | 170 | 126 | 30% | on | on | |
| 9 | 10 | 170 | 126 | 30% | on | on | |
| 10 | 10 | 160 | 109 | 20% | on | on | |
| 11 | 30 | 160 | 109 | 20% | on | on | pull at 0.90 |
| | | | | | | | water activity |
| 12 | open | 160 | 109 | 20% | off | off | |

The following table illustrates water activities in a non-limiting, exemplary test of a process embodiment of the present invention in Table 4.

| | | time at | | |
|---|---|---|---|---|
| | | 180° F. in | | |
| | time of | water bath | water | hit |
| Pull | pull | (minutes) | activity | target |
| 1:00 AM | 1:45 | 10 | 0.9606 | no |
| 1 b | 1:45 | 10 | 0.9230 | yes |
| 2 a | 2:25 | 10 | 0.9036 | yes |
| 2 b | 2:25 | 10 | 0.9044 | yes |
| | | | (thick) | |
| 3 a | 3:00 | 10 | 0.9225 | yes |
| 3 b | 3:00 | 10 | 0.9146 | yes |
| 4 a | 3:30 | 10 | 0.8700 | yes |
| | | | (thin) | |
| 4 b | 3:30 | 10 | 0.9252 | yes |
| | | | (thick) | |
| 5 a | 4:00 | 10 | 0.9126 | yes |
| 5 b | 4:00 | 10 | 0.8995 | yes |
| 6 | 4:30 | 10 | 0.9011 | yes |

Target water activity: 0.89 to 0.93

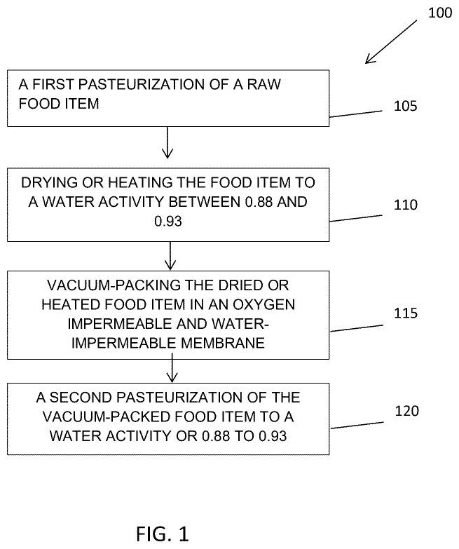

FIG. 1 shows a flowchart of a method embodiment of the present invention. Method 100 for preparing a shelf-stable, high-moisture food product begins with block 105, which includes a first pasteurization of a raw food item. Method 100 begins with drying or heating the pre-pasteurized food item to a water activity between 0.88 and 0.93 in block 110, e.g., 0.88, 0.87, 0.88, 0.90. 0.91, 0.92, or 0.93. Block 115 includes vacuum-packing the dried food item in an oxygen impermeable and water-impermeable membrane. In block 120, the vacuum-packed food item is pasteurized a second time. Method 100 may also be performed using an aseptic, continuous production line, with no human intervention and no exposure to microbes, in which case additional pasteurization may not be necessary. Some foods, such as fruits, may require the inclusion of one or more natural enzyme inhibitors to prevent browning, such as gluconic acid at 0.1% to 0.5% or glucose oxidase with at least 0.1% to 0.5% glucose present, which produces gluconic acid and eliminates oxygen.

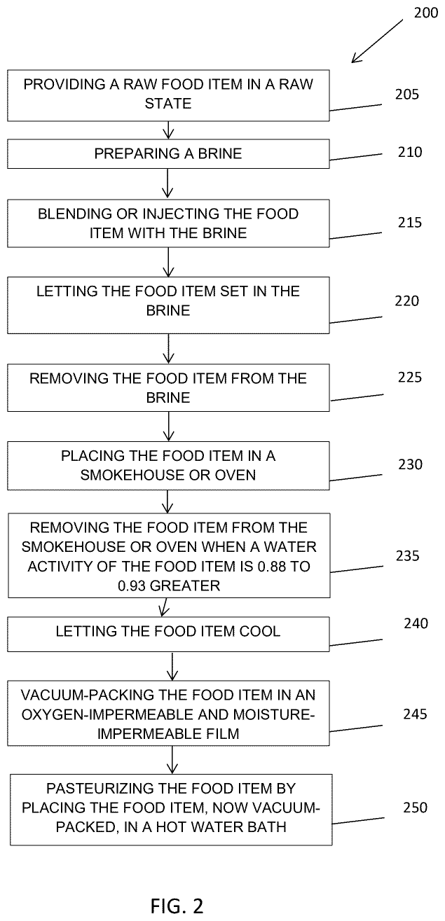

FIG. 2 depicts a flowchart of a method embodiment of the present invention. Method 200 for preparing a shelf-stable, high-moisture food product includes providing a food item in a raw state in block 205 and preparing a brine in block 210. Block 215 includes blending or injecting the food item and the brine by tumbling, block 220 includes letting the food item set in the brine, and block 225 includes removing the food item from the brine. Placing the food item in a smokehouse or oven is included in block 230. In block 235, removing the food item from the smokehouse or oven when a water activity of the food item is 0.88 to 0.93 or greater. In block 240, the food item is allowed to cool. Vacuum-packing the food item in an oxygen-impermeable and moisture-impermeable film is included in block 245. Finally, the food is pasteurized by placing the food item, now vacuum-packed, in a hot water bath in block 250. Method 200 may also be performed using an aseptic, continuous production line, with no human intervention and no exposure to microbes, in which case post-process pasteurization may not be necessary. Some foods, such as fruits, may require the inclusion of one or more natural enzyme inhibitors to prevent browning, such as gluconic acid at 0.1% to 0.5% or glucose oxidase with at least 0.1% to 0.5% glucose present, which produces gluconic acid and eliminates oxygen.

In one example, drying can also be done by simple air-drying or Enwave's microwave vacuum drying—especially for fruits and vegetables. A post-process pasteurization takes care of any contamination from these air-drying alternatives. For example, a post process pasteurization in the package can also accomplished in a heated, continuous tunnel (or steam tunnel), or an air impingement oven (continuous flow of hot air). What is important is to heat the product in the package at a set temperature and holding for a time sufficient to achieve pasteurization. For example, a hot water bath provides energy efficiency and complete, uniform heat transfer (no cold spots).

Using the method of the present disclosure it was found that 6 minutes at 77° C. for an 11 mm thick steak strip, at 0.89 to 0.90 water activity, was sufficient to get a 5.0 to 5.5 log kill of both Salmonella and Listeria. Depending on the thickness of the meat, the time may be increased or decreased, e.g., 1, 2, 3, 4, 5, 6, 7, 8, 9, 10, 12, 15, 20 or 25 minutes.

TABLE 5
Chicken breasts whole, skinless or strips
Chicken Breasts Whole, Skinless or Strips (0.90 to 0.92 water activity)

| | | | Chicken breast, | | Batch | | |
|---|---|---|---|---|---|---|---|
| | | | skinless: 2% fat + 5% | | size | | |
| | Jan. 14, 2025 | 0.893399564 | added = 7% fat | | pounds | | Grams |
| | Rotisserie Formula: Strips | | | 100 | 40 | | 453.5924 |
| | | whole, skinless | | | | | |
| | | chicken breasts or | | | | | |
| | Jun. 4, 2024 | flattened | % | | | Grams | |
| | Brine Emulsion (6% of chicken) | | % | | | chicken | 100.0000 |
| | Brine Emulsion | | | | | pump | 17.6500 |
| | | chicken breast | 85.00% | 85.00% | 3400.00% | | |
| 1 | open | distilled water | 4.00% | 4.00% | 160.00% | 725.7478 | |
| 2 | Ingredion | Skidmore's Q- | 0.15% | 0.15% | 6.00% | 27.2155 | |
| | | Naturale 200V, | | | | | |
| | | natural flavoring | | | | | |
| | | (Quillaja) | | | | | |
| 3 | A & B | Umami flavoring | 0.10% | 0.10% | 4.00% | 18.1437 | |
| | Ingredients | | | | | | |
| 4 | open | canola or high | 5.00% | 5.00% | 200.00% | 907.1848 | |
| | | oleic sunflower oil | | | | | |
| 5 | Kemin | MDT 10 mixed | 0.05% | 0.05% | 2.00% | 9.0718 | |
| | | tocopherols | | | | | |
| | | (vitamin E) | | | | | |
| 6 | Kerry/Red | fried flavor RA | 0.75% | 0.75% | 30.00% | 136.0777 | |
| | Arrow | 09020-05 OS | | | | | |

Preblend dry ingredients

| 7 | Sensient | Chicken flavor | 1.00% | 1.00% | 40.00% | |
|---|---|---|---|---|---|---|
| | | booster (1.0%) | | | | |
| 8 | open | plain salt | 1.20% | 1.20% | 48.00% | 217.7244 |
| 9 | Kemin | Kemin's Fortium | 0.10% | 0.10% | 4.00% | 18.1437 |
| | | RGT (0.10%) | | | | |
| 10 | Wenda | Wenda Phos 510H | 0.40% | 0.40% | 16.00% | 72.5748 |
| | | (0.5%) | | | | |
| 11 | Elite Spice | Rotisserie # | 1.25% | 1.25% | 50.00% | 226.7962 |
| | | 58939A2 | | | | |
| 12 | Wenda | Celery powder: | 0.40% | 0.40% | 16.00% | 72.5748 |
| | | BP 300 (120 ppm) | | | | |
| | | 0.4% | | | | |
| 13 | Biospringer- | Springarom CK | 0.10% | 0.10% | 4.00% | 18.1437 |
| | Lesaffre | 7005/30PW | | | | |
| | | (yeast extract) | | | | |
| 14 | Wenda | Koolgel M 2960 | 0.50% | 0.50% | 20.00% | 90.7185 |
| | | carrageenan | | | | |
| 15 | Sunita | 0.5% SLX 20 | 0.00% | 0.00% | 0.00% | 0.0000 |
| | hydrocolloids | Guar+ | | | | |
| 16 | Ingredion | 0.5% Gum Acacia | 0.00% | 0.00% | 0.00% | 0.0000 |
| | | BEV 202 | | | | |
| | Ingredion | Ticaloid 1155 | 0.00% | 0.00% | 0.00% | 0.0000 |
| | | (acacia, guar, | | | | |
| | | Xanthan) | | | | |
| | Initial Pasteurization Steps: | | 100.00% | 100.00% | 4000.00% | |
| | Chicken | | | | | |
| | Temperature | 165° F. (74° C.) | | | | |
| | Humidity | 95% to 98% | | | | |
| | Time | 1 minute | | | | |

Drying conditions
Parameter

| Temperature | 50° F. to 60° F. |
|---|---|
| | (10-16° C.) |

| | |
|---|---|
| Humidity | start 85%; 75%-80% |
| Air velocity | gentle/low |
| Time | 4 to 10 days |

Pasteurization can occur at a lower temperature and longer time. Procedure for Chicken Breasts Whole, Skinless or Strips of Table 5.
1. To make brine: add water, Quillaja and, with high-speed blender, slowly add the oil, plus other wet ingredients.
2. Blend the dry ingredients together separate from the wet emulsion. Then blend all ingredients together.
3. Inject into whole muscle.
4. Use the new smokehouse or oven schedule to dry or heat to a water activity of 0.89 to 0.92.
5. Vacuum pack in an oxygen and water impermeable film.
6. Pasteurize in a 150° F. to 160° F. water bath for 120 seconds, or 3, 4, 5, 6, 7, 8, 9, 10, 15, 20, 25, 40, 40, 45, 50, 60, 75, 90, 110, or 120 minutes or internal temperatures hit 145° F.
7. Immediately chill in an ice bath. Dry and store. Run micro tests to confirm full microbe kill.

In certain cases, the food item may or may not be smoked using burning wood chips or a liquid smoke extract is injected. In some cases, the meat is ground, and the brine is added and blended in. Typically, for whole muscle or chunk, the brine is injected. In the case of whole muscle, chicken breast is first injected with the brine, vacuum tumbled (optional to get best dispersion of the brine), cut into strips or left whole, then pasteurized (heat to at least 165 F for 1 second)—this can be in a smokehouse or a combi oven at a high humidity (optimal: 90% to 98%). It is then dried to a water activity between 0.88 to 0.93 (about 0.91 to 0.92). Drying or heating conditions are controlled so that the surface doesn't form a skin (pellicle or case hardening which would stop the drying). The variables are: temperature, humidity, air velocity and time at each set of the first three variables. The food product is then vacuum packed and placed in a 180 F to 185 F water bath for about 10 minutes (core, center temperature hits 165 F to complete the pasteurization a second time). The packed product can then be quickly chilled.

In one example, a combi oven (e.g., Cleveland Convotherm Combi Oven C4ED-10.20ES Full Size Electric Marine Version) is used to control the temperature, humidity and air velocity to dry thick, whole muscle chicken breasts, salmon or other meat slabs or chunks. Typically, a smokehouse does not control for air velocity and does not control the humidity and temperature with the precision required to dry a thick piece of meat or seafood. Snack meats (jerky and meat sticks) do not operate at these high humidities (75% to 85% humidity) for drying. Snack meats are more in the range of 40% to 45% relative humidity mainly because they are thin. In order to prevent a skin (pellicle or case hardening) forming which stops the drying process, it is preferably to dry slowly at a high humidity.

TABLE 6
Chicken brine composition.

| | | | | | | | pounds | |
|---|---|---|---|---|---|---|---|---|
| | | Chicken Brine | | | | 453.5924 | 120 | Grams |
| | | 15 gallons to prime injector = 120 # | | | | 743.4944238 | 1.2000 | 453.5924 |
| | | | | | 120 # | | | |
| 1 | open | distilled water | 4.0000% | 29.7398 | 35.6877 | | | |
| 2 | Ingredion | Skidmore's Q- | 0.1500% | 1.1152 | 1.3383 | | | 607.0382 |
| | | Naturale 200V, | | | | | | |
| | | natural flavoring | | | | | | |
| | | (Quillaja) | | | | | | |
| 3 | A & B | Umami | 0.1000% | 0.7435 | 0.8922 | | | 404.6921 |
| | Ingredients | flavoring | | | | | | |
| 4 | open | canola or high | 5.0000% | 37.1747 | 44.6097 | | | |
| | | oleic sunflower | | | | | | |
| | | oil | | | | | | |
| 5 | Kemin | MDT 10 mixed | 0.0500% | 0.3717 | 0.4461 | | | 202.3461 |
| | | tocopherols | | | | | | |
| | | (vitamin E) | | | | | | |
| 6 | Kerry/Red | fried flavor RA | 0.0500% | 0.3717 | 0.4461 | | | 202.3461 |
| | Arrow | 09020-05 OS | | | | | | |
| | | (0.75%) | | | | | | |
| 7 | Biorigin | Biotaste CH | 0.15% | 1.1152 | 1.3383 | | | |
| 8 | open | plain salt | 1.2000% | 8.9219 | 10.7063 | | | |
| 9 | Kemin | Kemin's | 0.1000% | 0.7435 | 0.8922 | | | 404.6921 |
| | | Fortium RGT | | | | | | |
| | | (0.10%) | | | | | | |
| 10 | Wenda | Wenda Phos | 0.4000% | 2.9740 | 3.5688 | | | |
| | | 510H (0.5%) | | | | | | |
| 11 | Elite | Rotisserie # | 1.2500% | 9.2937 | 11.1524 | | | |
| | Spice | 58939A2 | | | | | | |
| 12 | Wenda | Celery powder: | 0.4000% | 2.9740 | 3.5688 | | | |
| | | BP 300 | | | | | | |
| | | (120 ppm) 0.4% | | | | | | |
| 13 | Biorigin | maxarome | 0.1000% | 0.7435 | 0.8922 | | | 404.6921 |
| | | premium or | | | | | | |
| | | Biorigin GMX | | | | | | |
| | | 18 | | | | | | |
| 14 | Wenda | Koolgel M 2960 | 0.5000% | 3.7175 | 4.4610 | | | |
| | | carrageenan | | | | | | |
| 15 | Sunita | 0.5% SLX 20 | 0.0000% | 0.0000 | 0.0000 | | | |
| | hydro- | Guar + | | | | | | |
| | colloids | | | | | | | |
| 16 | Ingredion | 0.5% Gum | 0.0000% | 0.0000 | 0.0000 | | | |
| | | Acacia BEV 202 | | | | | | |
| | | | 13.4500% | 100.0000 | 120.0000 | | | |

Drying conditions

| Parameter | Initial Pasteurization |
|---|---|
| | Steps: Chicken |

| Temperature | 50° F. to 60° C. | Temperature | 165° F. |
|---|---|---|---|
| | (10-16° C.) | | (74° C.) |
| Humidity | start 85%; | Humidity | 95% to |
| | 75%-80% | | 98% |

| | | | |
|---|---|---|---|
| Air velocity | gentle/low | Time | 1 minute |
| Time | 4 to 10 days | | |

TABLE 7
Heating schedule and pathogen elimination.
Chicken Heating

| | Cook | Dry | Wet | | | | | Special | |
|---|---|---|---|---|---|---|---|---|---|
| | time | Bulb | bulb | RH | | | | Notes on | Jan. 1, |
| Stage | (minutes) | (° F.) | (° F.) | (%) | BTU's | Exhaust | Steam | Process | 2025 |
| 1 | 10 | 120 | 100 | 50 | 71 | open | on | No smoke used | lethality |
| 2 | 10 | 120 | 100 | 50 | 71 | open | on | | zone: |
| 3 | 10 | 140 | 125 | 65 | 135 | open | on | | could |
| 4 | 10 | 160 | 145 | 68 | 235 | open | on | | go to |
| 5 | 10 | 175 | 160 | 70 | 237 | open | on | | 140 F. |
| 6 | 10+ | 185 | 170 | 71 | 536 | open | on | stop when hits | for a |
| | | | | | | | | 170 F. | longer |
| | | | | | | | | (or 140 F.) | time |
| 7 | 35 | 180 | 140 | 36 | 203 | open | on | | drying |
| 8 | 35 | 180 | 140 | 36 | 203 | open | on | | steps |
| 9 | open | 110 | 92 | 51 | 58 | open | on | | |
| 10 | | 110 | 93 | 53 | 60 | open | on | | |

| | | | | | | |
|---|---|---|---|---|---|---|
| 11 | 110 | 95 | 58 | 63 | open | on |
| 12 | 110 | 97 | 63 | 66 | open | on |
| 13 | 110 | 98 | 65 | 68 | open | on |
| 14 | 110 | 100 | 70 | 71 | open | on |
| 15 | 110 | 102 | 75 | 75 | open | on |
| 16 | | | | | open | on |
| 17 | | | | | open | on |

After processing, vacuum pack and pasteurize in a hot water bath (140 F. for 120+ minutes).
Immediately chill after pasteurization.

| Inactivation of Listeria monocytogenes | | 5-log Reduction of Pathogens in Meats (USDA) |
|---|---|---|
| Internal | Internal | |

| temper- | temper- | | | temper- | temper- | |
|---|---|---|---|---|---|---|
| ature | ature | lethal | time | ature | ature | Time for a 5-log |
| F. | C. | rate | (minutes) | F. | C. | reduction |
| 145 | 63 | 0.117 | 17.0 | 145 | 62.8 | 3 minutes |
| 147 | 64 | 0.158 | 12.7 | 146 | 63.3 | 130 seconds |
| 149 | 65 | 0.215 | 9.3 | 147 | 63.9 | 103 seconds |
| 151 | 66 | 0.293 | 6.8 | 148 | 64.4 | 82 seconds |
| 153 | 67 | 0.398 | 5.0 | 149 | 65 | 65 seconds |
| 154 | 68 | 0.541 | 3.7 | 150 | 65.6 | 52 seconds |
| 156 | 69 | 0.736 | 2.7 | 152 | 66.1 | 41 seconds |

| Drying conditions | | Drying conditions | |
|---|---|---|---|
| Parameter | | Parameter | |
| Temperature | 50° F. to 60° F. | Temperature | 50° F. to 60° F. |
| | (10-16° C.) | | (10-16° C.) |
| Humidity | start 85%; | Humidity | start 85%; |
| | 75%-80% | | 75%-80% |
| Air velocity | gentle/low | Air velocity | gentle/low |
| Time | 4 to 10 days | Time | 4 to 10 days |

TABLE 8
Alternative heating conditions.
Chicken Heating

| | Cook | Dry | Wet | | | | | Special | |
|---|---|---|---|---|---|---|---|---|---|
| | time | Bulb | bulb | RH | | | | Notes on | Jan. 1, |
| Stage | (minutes) | (° F.) | (° F.) | (%) | BTU's | Exhaust | Steam | Process | 2025 |
| 1 | 10 | 120 | 110 | 72 | 92 | open | on | No smoke | lethality |
| | | | | | | | | used | zone: |
| 2 | 10 | 120 | 115 | 85 | 104 | open | on | | Go to |
| 3 | 10 | 140 | 135 | 87 | 178 | open | on | | 150 F. |
| 4 | 10 | 145 | 140 | 87 | 204 | open | on | | for a |
| 5 | 10 | 150 | 145 | 88 | 236 | open | on | | longer |
| 6 | 20 | 155 | 150 | 88 | 273 | open | on | Stop when | time |
| 7 | open | 160 | 155 | 88 | 310 | open | on | hits 150 F. | |
| 8 | open | 160 | 155 | 88 | 310 | open | on | internal | |
| | | | | | | | | (or 66 C.) | |
| 9 | open | 110 | 92 | 51 | 58 | open | on | Optimize | drying |
| 10 | | 110 | 93 | 53 | 60 | open | on | the time & | steps |
| 11 | | 110 | 95 | 58 | 63 | open | on | temperature | |
| 12 | | 110 | 97 | 63 | 66 | open | on | to get the | |
| 13 | | 110 | 98 | 65 | 68 | open | on | best | |
| 14 | | 110 | 100 | 70 | 71 | open | on | texture | |
| 15 | | 110 | 102 | 75 | 75 | open | on | | |
| 16 | | | | | | open | on | | |
| 17 | | | | | | open | on | | |

After processing, vacuum pack and pasteurize in a hot water bath (140 F. for 120+ minutes).
Immediately chill after pasteurization.

| Inactivation of Listeria monocytogenes | | | | 5-log Reduction of Pathogens in Meats (USDA) | | |
|---|---|---|---|---|---|---|
| Internal | Internal | | | | | Time |
| temper- | temper- | | | temper- | temper- | for |
| ature | ature | lethal | time | ature | ature | a 5-log |
| F. | C. | rate | (minutes) | F. | C. | reduction |
| 145 | 63 | 0.117 | 17.0 | 145 | 62.8 | 3 minutes |
| 147 | 64 | 0.158 | 12.7 | 146 | 63.3 | 130 seconds |
| 149 | 65 | 0.215 | 9.3 | 147 | 63.9 | 103 seconds |
| 151 | 66 | 0.293 | 6.8 | 148 | 64.4 | 82 seconds |
| 153 | 67 | 0.398 | 5.0 | 149 | 65 | 65 seconds |
| 154 | 68 | 0.541 | 3.7 | 150 | 65.6 | 52 seconds |
| 156 | 69 | 0.736 | 2.7 | 152 | 66.1 | 41 seconds |

TABLE 9
Salmon brine conditions

| | | | | | | | pounds | |
|---|---|---|---|---|---|---|---|---|
| | | Atlantic Salmon Brine | | | | 453.5924 | 120 | Grams |
| | | 15 gallons to prime injector = 120 # | | | | 5.142710208 | 1.200 | 453.5924 |
| 1 | wet | Kemin | mixed tocopherols | 0.0250 | 0.0250% | 0.1286 | 0.154 | 58.32 |
| | | | (Kemins MDT 10) | | | | | |
| | | | 0.05% | | | | | |
| 2 | wet | bottled | water, distilled | 15.0000 | 15.0000% | 77.1407 | 92.569 | |
| 3 | wet | Ingredion | Quillaja, natural | 0.0200 | 0.0200% | 0.1029 | 0.123 | 46.65 |
| | | | flavoring (0.50%) | | | | | |
| 4 | wet | Kerry | Charoil Hickory | 0.1000 | 0.1000% | 0.5143 | 0.617 | 233.27 |
| | | | smoke (0.2%) | | | | | |
| 5 | dry | open | brown sugar (1.5%) | 1.4000 | 1.4000% | 7.1998 | 8.640 | |
| 6 | dry | Kemin | Fortium RGT | 0.1000 | 0.1000% | 0.5143 | 0.617 | 233.27 |
| | | | (0.10%) | | | | | |
| 7 | dry | Wenda | Celery powder: BP | 0.4000 | 0.4000% | 2.0571 | 2.469 | |
| | | | 300 (120 ppm) 0.4% | | | | | |
| 8 | dry | open | plain salt (1.4%) | 1.4000 | 1.4000% | 7.1998 | 8.640 | |
| 9 | dry | Wenda | Wenda Koolgel | 0.5000 | 0.5000% | 2.5714 | 3.086 | |
| | | | M2960 kappa & Iota | | | | | |
| | | | carrageenan (0.5%) | | | | | |
| 10 | dry | Wenda | Wenda Phos 501H | 0.5000 | 0.5000% | 2.5714 | 3.086 | |
| | | | (0.5%) | | | | | |

| Pump Levels | | 19.4450 | 4.4200% | 100.0000 | 120.000 |
|---|---|---|---|---|---|
| Salmon | 100 | | | | |

| | | |
|---|---|---|
| Brine | 26 | water~8.34#/gallon; |
| | | oil~7.6#/gallon |

Drying conditions

| | |
|---|---|
| Parameter | |
| Temperature | 50° F. to 60° F. |
| | (10-16° C.) |
| Humidity | start 85%; 75%-80% |
| Air velocity | gentle/low |
| Time | 4 to 10 days |

Initial Pasteurization step: seafood

| | |
|---|---|
| Temperature | 145° F./63° C. |
| Time | 17 minutes |
| Humidity | 95% to 98% |

TABLE 10
Atlantic salmon chunks
Atlantic Salmon Chunks (0.90 water activity) farm raised

| | | | | Target fat: | | | | |
|---|---|---|---|---|---|---|---|---|
| | | | | unchanged | | pounds | | Grams |
| | Atlantic salmon (13.4% fat) | | | | batch size | 20.0000 | | 453.5924 |
| | Atlantic Salmon | | | 80.5550 | 80.5550% | 16.1110 | | |
| Order | | Brine Emulsion | | | | | | |
| of | | | base | | | | Emulsion | |
| addition | | % | emulsion | | | | Grams | |
| 1 | wet | Kemin | mixed tocopherols | 0.0250 | 0.0250% | 0.0050 | 2.2680 | |
| | | | (Kemins MDT 10) | | | | | |
| | | | 0.05% | | | | | |
| 2 | wet | bottled | water, distilled | 15.0000 | 15.0000% | 3.0000 | | |
| 3 | wet | Ingredion | Quillaja, natural | 0.0200 | 0.0200% | 0.0040 | 1.8144 | |
| | | | flavoring (0.50%) | | | | | |
| 4 | wet | Kerry | Charoil Hickory smoke | 0.1000 | 0.1000% | 0.0200 | 9.0718 | |
| | | | (0.2%) | | | | | |
| | Dry blend together | | | | | | | |
| 5 | dry | Kemin | Fortium RGT (0.10%) | 0.1000 | 0.1000% | 0.0200 | 9.0718 | |
| 6 | dry | Wenda | Celery powder: BP 300 | 0.4000 | 0.4000% | 0.0800 | 36.2874 | |
| | | | (120 ppm) 0.4% | | | | | |
| 7 | dry | open | plain salt (1.4%) | 1.4000 | 1.4000% | 0.2800 | 127.0059 | |
| 8 | dry | open | brown sugar | 1.4000 | 1.4000% | 0.2800 | 127.0059 | |
| 9 | dry | Wenda | Wenda Koolgel M2960 | 0.5000 | 0.5000% | 0.1000 | 45.3592 | |
| | | | kappa & Iota | | | | | |
| | | | carrageenan (0.5%) | | | | | |
| 10 | dry | Wenda | Wenda Phos 501H | 0.5000 | 0.5000% | 0.1000 | 45.3592 | |
| | | | (0.5%) | | | | | |
| | | Kerry/ | Charoil Applewood | | | | | |
| | | red | smoke 25 | | | | | |
| | | arrow | | | | | | |
| | | | | 100.0000 | 100.0000% | 20.0000 | | |

shelf-stability and the best possible texture.
Kirkland cooked & hot smoked Atlantic salmon

| sugar | 1.78% | Pump levels | |
|---|---|---|---|
| salt | 2.18% | Salmon | 100 |
| protein | 9.80% | Brine | 26 |

Steps for Salmon chunks.
1. Wet and dry ingredients are blended, then injected into the salmon.
2. Use new smokehouse or oven schedule to pasteurize and, if applicable, heat and/or dry (0.90 to 0.92 water activity).
3. Vacuum pack then re-pasteurize using the low temperature, longer time process to achieve to shelf-stability and the best possible texture.

TABLE 11
Sockeye salmon chunks

| | Sockeye Salmon Chunks Research (0.90 water activity) | | | | | | | |
|---|---|---|---|---|---|---|---|---|
| | | | | Target fat: 9.8% | | pounds | | Grams |
| | Wild Sockeye salmon (7.3% fat) | | | | batch size | 20.0000 | | 453.5924 |
| | Sockeye Salmon | | | 84.0050 | 84.0050% | 16.8010 | | |
| Order | | Brine Emulsion | | | | | | |
| of | | | base | | | | Emulsion | |
| addition | | % | emulsion | | | | Grams | |
| 1 | wet | Kemin | mixed | 0.0250 | 0.0250% | 0.0050 | 2.2680 | |
| | | | tocopherols | | | | | |
| | | | (Kemins | | | | | |
| | | | MDT 10) | | | | | |
| | | | 0.05% | | | | | |
| 2 | wet | | water, | 10.0000 | 10.0000% | 2.0000 | | |
| | | | distilled | | | | | |
| 3 | wet | Ingredion | Quillaja, | 0.0700 | 0.0700% | 0.0140 | 6.3503 | |
| | | | natural | | | | | |
| | | | flavoring | | | | | |
| | | | (1.50%) | | | | | |
| 4 | wet | Costco | Virgin | 2.5000 | 2.5000% | 0.5000 | 226.7962 | |
| | | | Olive oil | | | | | |
| | | | (50%) | | | | | |
| | Dry blend together | | | | | | | |
| 5 | dry | open | Spice (no | 0.0000 | 0.0000% | 0.0000 | 0.0000 | |
| | | | salt added) | | | | | |
| 6 | dry | Kemin | Fortium | 0.1000 | 0.1000% | 0.0200 | 9.0718 | |
| | | | RGT | | | | | |
| | | | (0.10%) | | | | | |
| 7 | dry | Wenda | Celery | 0.4000 | 0.4000% | 0.0800 | 36.2874 | |
| | | | powder: | | | | | |
| | | | BP 300 | | | | | |
| | | | (120 ppm) | | | | | |
| | | | 0.4% | | | | | |
| 8 | dry | open | plain salt | 1.4000 | 1.4000% | 0.2800 | 127.0059 | |
| | | | (1.4%) | | | | | |
| 9 | dry | Wenda | Wenda | 0.5000 | 0.5000% | 0.1000 | 45.3592 | |
| | | | Koolgel | | | | | |
| | | | M2960 | | | | | |
| | | | kappa & | | | | | |
| | | | Iota | | | | | |
| | | | carrageenan | | | | | |
| | | | (0.5%) | | | | | |
| 10 | dry | Sunita | 0.5% SLX | 0.5000 | 0.5000% | 0.1000 | 45.3592 | |
| | | hydrocolloids | 20 Guar + | | | | | |
| 11 | dry | Wenda | Wenda | 0.5000 | 0.5000% | 0.1000 | 45.3592 | |
| | | | Phos 501H | | | | | |
| | | | (0.5%) | | | | | |
| | | | | 100.0000 | 100.0000% | 20.0000 | | |

1. Blend wet and dry ingredients, then inject into the salmon.
2. Use new smokehouse or oven schedule to pasteurize and dry (0.90 to 0.92 water activity)
3. Vacuum pack then re-pasteurize using the low temperature, longer timed process to achieve shelf-stability and the best possible texture.

TABLE 12
Heating conditions #1 and microbiology.
Seafood Heating

| | Cook | Dry | Wet | | | | | Special | |
|---|---|---|---|---|---|---|---|---|---|
| | time | Bulb | bulb | RH | | | | Notes on | |
| Stage | (minutes) | (° F.) | (° F.) | (%) | BTU's | Exhaust | Steam | Process | |
| 1 | 10 | 120 | 110 | 72 | 92 | open | on | No smoke | lethality |
| | | | | | | | | used | zone: |
| 2 | 10 | 120 | 115 | 85 | 104 | open | on | | Go to |
| 3 | 10 | 140 | 135 | 87 | 178 | open | on | | 145 F. |
| 4 | 10 | 145 | 140 | 87 | 204 | open | on | | to 150 |
| 5 | 10 | 150 | 145 | 88 | 236 | open | on | try at 145 F. | F. for a |
| 6 | 20 | 155 | 150 | 88 | 273 | open | on | Stop when | longer |
| 7 | open | 160 | 155 | 88 | 310 | open | on | hits 150 F. | time |
| 8 | open | 160 | 155 | 88 | 310 | open | on | internal | |
| | | | | | | | | (or 66 C.) | |
| 9 | open | 110 | 92 | 51 | 58 | open | on | Optimize | drying |
| 10 | | 110 | 93 | 53 | 60 | open | on | the time & | steps |
| 11 | | 110 | 95 | 58 | 63 | open | on | temperature | |
| 12 | | 110 | 97 | 63 | 66 | open | on | to get | |
| 13 | | 110 | 98 | 65 | 68 | open | on | the best | |
| 14 | | 110 | 100 | 70 | 71 | open | on | texture | |
| 15 | | 110 | 102 | 75 | 75 | open | on | | |
| 16 | | | | | | open | on | | |
| 17 | | | | | | open | on | | |

After processing, vacuum pack and pasteurize in a hot water bath (140° F. for 120+ minutes).
Immediately chill after pasteurization.

| Inactivation of Listeria monocytogenes | | | | 5-log Reduction of Pathogens in Meats (USDA) | | |
|---|---|---|---|---|---|---|
| Internal | Internal | | | | | Time |
| temper- | temper- | | | temper- | temper- | for |
| ature | ature | lethal | time | ature | ature | a 5-log |
| F. | C. | rate | (minutes) | F. | C. | reduction |
| 140 | 60 | | | 140 | 60 | 9 minutes |
| 145 | 63 | 0.117 | 17.0 | 145 | 62.8 | 3 minutes |
| 147 | 64 | 0.158 | 12.7 | 146 | 63.3 | 130 seconds |
| 149 | 65 | 0.215 | 9.3 | 147 | 63.9 | 103 seconds |
| 151 | 66 | 0.293 | 6.8 | 148 | 64.4 | 82 seconds |
| 153 | 67 | 0.398 | 5.0 | 149 | 65 | 65 seconds |
| 154 | 68 | 0.541 | 3.7 | 150 | 65.6 | 52 seconds |
| 156 | 69 | 0.736 | 2.7 | 152 | 66.1 | 41 seconds |

TABLE 13
Heating conditions #2 and microbiology.
Salmon Smokehouse or oven Schedule 2025 Plans

| | Cook | Dry | Wet | | | | | | |
|---|---|---|---|---|---|---|---|---|---|
| | time | Bulb | bulb | RH | | | | Special Notes on | Jan. 1, |
| Stage | (minutes) | (° F.) | (° F.) | (%) | BTU's | Exhaust | Steam | Process | 2025 |
| 1 | 10 | 120 | 100 | 50 | 71 | open | on | No smoke used | lethality |
| 2 | 10 | 120 | 100 | 50 | 71 | open | on | | zone: |
| 3 | 10 | 140 | 125 | 65 | 135 | open | on | | could |
| 4 | 10 | 160 | 145 | 68 | 235 | open | on | | go to |
| 5 | 10 | 175 | 160 | 70 | 237 | open | on | | 140 F. |
| 6 | 10+ | 185 | 170 | 71 | 536 | open | on | stop when hits 170 F. | for a |
| | | | | | | | | (or 140 F.) | longer |
| | | | | | | | | | time |
| 7 | 35 | 180 | 140 | 36 | 203 | open | on | | drying |
| 8 | 35 | 180 | 140 | 36 | 203 | open | on | | steps |
| 9 | open | 110 | 92 | 51 | 58 | open | on | | |
| 10 | | 110 | 93 | 53 | 60 | open | on | | |
| 11 | | 110 | 95 | 58 | 63 | open | on | | |
| 12 | | 110 | 97 | 63 | 66 | open | on | | |
| 13 | | 110 | 98 | 65 | 68 | open | on | | |
| 14 | | 110 | 100 | 70 | 71 | open | on | | |
| 15 | | 110 | 102 | 75 | 75 | open | on | | |
| 16 | | | | | | open | on | | |
| 17 | | | | | | open | on | | |

After processing, vacuum pack and pasteurize in a hot water bath (140° F. for 120+ minutes).
Immediately chill after pasteurization.

| Inactivation of Listeria monocytogenes | | | | 5-log Reduction of Pathogens in Meats (USDA) | | |
|---|---|---|---|---|---|---|
| Internal | Internal | | | | | Time |
| temper- | temper- | | | temper- | temper- | for |
| ature | ature | lethal | time | ature | ature | a 5-log |
| F. | C. | rate | (minutes) | F. | C. | reduction |
| 145 | 63 | 0.117 | 17.0 | 145 | 62.8 | 3 minutes |
| 147 | 64 | 0.158 | 12.7 | 146 | 63.3 | 130 seconds |
| 149 | 65 | 0.215 | 9.3 | 147 | 63.9 | 103 seconds |
| 151 | 66 | 0.293 | 6.8 | 148 | 64.4 | 82 seconds |
| 153 | 67 | 0.398 | 5.0 | 149 | 65 | 65 seconds |
| 154 | 68 | 0.541 | 3.7 | 150 | 65.6 | 52 seconds |
| 156 | 69 | 0.736 | 2.7 | 152 | 66.1 | 41 seconds |

TABLE 14
Coho/silver salmon chunks

| | | Coho/Silver Salmon Chunks Research (0.90 water activity) | | | | | | |
|---|---|---|---|---|---|---|---|---|
| | | | | Target fat: 9.9% | | pounds | | Grams |
| | | | Wild Coho | | batch | 20.0000 | | 453.5924 |
| | | | salmon (5.9% fat) | | size | | | |
| | | | Farmed Coho | 82.4500 | 82.4500% | 16.4900 | | |
| | | | salmon (7.7% fat) | | | | | |
| Order | | | | | | | | |
| of | | Brine Emulsion | | | | | Emulsion | |
| addition | | % | base emulsion | | | | Grams | |
| 1 | wet | Kemin | mixed | 0.0400 | 0.0400% | 0.0080 | 3.6287 | |
| | | | tocopherols | | | | | |
| | | | (Kemins MDT | | | | | |
| | | | 10) 0.05% | | | | | |
| 2 | wet | | water, distilled | 10.0000 | 10.0000% | 2.0000 | | |
| 3 | wet | Ingredion | Quillaja, natural | 0.1100 | 0.1100% | 0.0220 | 9.9790 | |
| | | | flavoring | | | | | |
| | | | (1.50%) | | | | | |
| 4 | wet | Costco | Olive oil (50%) | 4.0000 | 4.0000% | 0.8000 | 362.8739 | |
| Dry blend together | | | | | | | | |
| 5 | dry | open | Spice (no salt | 0.0000 | 0.0000% | 0.0000 | 0.0000 | |
| | | | added) | | | | | |
| 6 | dry | Kemin | Fortium RGT | 0.1000 | 0.1000% | 0.0200 | 9.0718 | |
| | | | (0.10%) | | | | | |
| 7 | dry | Wenda | Celery powder: | 0.4000 | 0.4000% | 0.0800 | 36.2874 | |
| | | | BP 300 | | | | | |
| | | | (120 ppm) 0.4% | | | | | |
| 8 | dry | open | plain salt | 1.4000 | 1.4000% | 0.2800 | 127.0059 | |
| | | | (1.4%) | | | | | |
| 9 | dry | Wenda | Wenda Koolgel | 0.5000 | 0.5000% | 0.1000 | 45.3592 | |
| | | | M2960 kappa | | | | | |
| | | | & Iota | | | | | |
| | | | carrageenan | | | | | |
| | | | (0.5%) | | | | | |
| 10 | dry | Sunita | 0.35% SLX 20 | 0.5000 | 0.5000% | 0.1000 | 45.3592 | |
| | | hydro- | Guar+ | | | | | |
| | | colloids | | | | | | |
| 11 | dry | Wenda | Wenda Phos | 0.5000 | 0.5000% | 0.1000 | 45.3592 | |
| | | | 501H (0.5%) | | | | | |
| 12 | dry | Ingredion | Ticaloid 1155 | 0.0000 | 0.0000% | 0.0000 | 0.0000 | |
| | | | (Gum | | | | | |
| | | | Arabic/guar/ | | | | | |
| | | | Xanthan Gum) | | | | | |
| | | | 0.5% | | | | | |
| 13 | dry | Ingredion | 0.5% Gum | 0.0000 | 0.0000% | 0.0000 | 0.0000 | |
| | | | Acacia BEV | | | | | |
| | | | 202 | | | | | |
| | | | | 100.0000 | 100.0000% | 20.0000 | | |

1. Blend wet and dry ingredients, then inject into the salmon.
2. Use new smokehouse or oven schedule to pasteurize and dry (0.90 to 0.92 water activity).
3. Vacuum pack then re-pasteurize using the low temperature, longer timed process to achieve shelf-stability and the best possible texture.

In addition, the present invention can be used as a process for fruit snacks (e.g. mangos, strawberries, etc.) and vegetables (e.g. carrots), in which the final fruit/vegetable has a soft texture, easy to chew shelf-stable snack. For fruits, in particular, because they have a lower pH (e.g., 3.5-4.2), the time or temperature can be decreased. The same applies to any acidified product or naturally acid product such as fruits. As pH goes down, it takes less time or temperature to achieve lethality. As such, the time and temperature can be reduced.

In addition, gluconic acid can be added to the food item to inhibit the enzymatic browning of, e.g., fruits, vegetable, and seafood (e.g., shrimp). The addition of gluconic acid prevents the enzymes from causing the product to darken or go black.

Another method of the present disclosure includes one or more osmotic pressure set water baths, providing for the two-step pasteurization process that eliminates the formation of the pellicle (e.g., with fish and fowl). The two-step process involves, drying to a water activity to the food product to, e.g., 0.90-0.92 in a water permeable membrane, pulling the food product out of the water, and putting into a second membrane (water/O₂ impermeable) to pasteurize a second time.

The skilled artisan will recognize that the present invention provides an all-natural food that has no preservatives, that has a texture is soft and easy to chew, and that requires no gas flushing and an oxygen absorber. This process also allows the moisture to go higher (0.88 to 0.93) to enhance the moistness and to generate a softer, more pleasant texture and softer chewability.

For example, the drying or heating process, can use successive differences in one or more osmotic pressure solutions to pace the drying rate and/or adding differing temperatures to pace the drying plus add in a pasteurization step during the drying process (1st pasteurization), and after the drying or heating is completed with the food product in a water permeable barrier being repacked in its final oxygen and water impermeable barrier, and then given the final pasteurization treatment (2nd pasteurization). For example, using a combination oven, such as a CONTHERM™ oven, the inventors were able to pasteurize and dry whole chicken breasts and salmon slabs to between 75-85% relative humidity for several days without getting a pellicle or sealed skin. Alternatively, osmotic drying can be used to achieve a 75-85% relative humidity without getting a pellicle or sealed skin.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property (ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke 35 U.S.C. § 112 (f) as it exists on the date of filing hereof unless the words “means for” or “step for” are explicitly used in the particular claim.

What is claimed is:

1. A method for preparing a shelf-stable, high-moisture food product, comprising:
a first pasteurizing step of a food item to kill microbes except spores comprising heating the pasteurized food item to a water activity between 0.88 and 0.92, wherein the food product is at least one of: heated to a final internal temperature of 160° F. for one minute; heated to a final internal temperature of 165° F. for one second; or heated to a final internal temperature of 165° F.;
vacuum-packing the heated food product in an oxygen impermeable and water-impermeable membrane, wherein no preservatives are added, no gas flushing is performed, and no oxygen absorber is added and having a water activity between 0.88 and 0.92; and
a second pasteurizing step of the food item in a package, wherein the food item in the package is shelf-stable and has a water activity of 0.88 and 0.92.

2. The method of claim 1, wherein the food product comprises beef, chicken, fish, fruit, vegetable, nuts, seeds, or a blend thereof.

3. The method of claim 1, wherein food item is processed in a continuous production line.

4. The method of claim 1, wherein the food item is dried to a water activity between 0.88 and 0.92.

5. The method of claim 1, wherein the food item is dried to a water activity of about 0.90.

6. The method of claim 1, wherein the food item is dried to a water activity of 0.88, 0.90. 0.91, 0.92, or 0.93.

7. The method of claim 1, wherein no preservatives are added.

8. The method of claim 1, wherein no gas flushing is performed.

9. The method of claim 1, wherein no oxygen absorber is added.

10. The method of claim 1, further comprising treating the food product with one or more natural enzyme inhibitors.

11. The method of claim 1, wherein the heating is dry or humid.

12. The method of claim 1, further comprising heating the food product to at least 77° C. for a time sufficient to kill Salmonella and Listeria with at least a 5.0 log kill.

13. The method of claim 1, wherein the first, the second, or both the first and second pasteurizing steps are a two-step process: (1) drying or heating the food product to a water activity to the food product to 0.90-0.92 in a water permeable membrane in a water bath, and (2) drying or heating the food product in a second membrane that is water/02 impermeable in the water bath.

14. A method of preparing a shelf-stable, high-moisture food product, comprising:
a first pasteurizing step of a raw food item to kill microbes except spores by heating the food item to a water activity 0.88 to 0.92, wherein the food product is at least one of: heated to a final internal temperature of 160° F. for one minute; heated to a final internal temperature of 165° F. for one second; or heated to a final internal temperature of 165° F.; and
vacuum-packing the heated food item in an oxygen impermeable and water-impermeable membrane, wherein no preservatives are added, no gas flushing is performed, and no oxygen absorber is added, and having a water activity between 0.88 and 0.92; and
after vacuum-packing the heated food item, then a second pasteurizing step of the food item in a package, wherein the food item in the package is shelf-stable and a water activity of 0.88 and 0.92.

15. A method for preparing a shelf-stable, high-moisture food item, comprising:
providing a raw food item in a raw state;
preparing a brine;
blending or injecting the food item and the brine;
letting the food item set with the brine;
removing the food item from any excess brine;
placing the food item in an oven or smokehouse or oven;
removing the food item from the smokehouse or oven when a water activity of the food item is between 0.88 and 0.93;
letting the food item cool;
vacuum-packing the food item in an oxygen-impermeable and moisture-impermeable film; and
a pasteurizing step of the food item by placing the food item, now vacuum-packed, wherein the food item is at least one of:
dried or heated with a final internal temperature of 160° F. for one minute;
dried or heated with a final internal temperature of 165° F. for one second; or
dried or heated with a final internal temperature of 165° F., wherein no preservatives are added, no gas flushing is performed, and no oxygen absorber is added, wherein the food item is shelf-stable and has a water activity of 0.88 and 0.93.

16. A shelf-stable, high-moisture food product made by the method comprising:
a first pasteurizing step of the food product to kill microbes except spores comprising heating the pasteurized food item to a water activity between 0.88 and 0.93, wherein the food product is at least one of: heated to a final internal temperature of 160° F. for one minute; heated to a final internal temperature of 165° F. for one second; or heated to a final internal temperature of 165° F.;
vacuum-packing the heated food product in an oxygen impermeable and water-impermeable membrane, wherein no preservatives are added, no gas flushing is performed, and no oxygen absorber is added and having a water activity between 0.88 and 0.93; and
a second pasteurizing step of the food item in a package, wherein the food item in the package is shelf-stable and has a water activity of 0.88 and 0.93.

17. The food product of claim 16, wherein the food item comprises beef, chicken, fish, fruit, vegetable, nuts, seeds, or a blended food.

18. The food product of claim 16, wherein the food product is processed in a continuous production line.

19. The food product of claim 16, wherein the food product is dried to a water activity between 0.88 and 0.92.

20. The food product of claim 16, wherein the food product is dried to a water activity of about 0.90.

21. The food product of claim 16, wherein the food product is dried to a water activity of 0.88, 0.90. 0.91, 0.92, or 0.93.

22. The food product of claim 16, wherein no preservatives are added.

23. The food product of claim 16, wherein no gas flushing is performed.

24. The food product of claim 16, wherein no oxygen absorber is added.

25. The food product of claim 16, wherein the food product is treated with one or more natural enzyme inhibitors.

26. The food product of claim 16, wherein the product is heated to at least 77° C. for a time sufficient to kill Salmonella and Listeria with at least a 5.0 log kill.
